(19) United States
(12) Patent Application Publication
(10) Pub. No.: US 2008/0308430 A1
(43) Pub. Date: Dec. 18, 2008

(54) Packaging for a Disposable Item

(75) Inventors: Joanna Wojtalik, Victoria (AU); Alexander Nicholas McKinnon, Victoria (AU)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: MODERN MEDIA CONCEPTS PTY LTD, Melbourne (AU)

(21) Appl. No.: 11/720,976

(22) PCT Filed: Dec. 6, 2005
(86) PCT No.: PCT/AU05/01845

§ 371 Date: Feb. 28, 2008

(30) Foreign Application Priority Data
Dec. 6, 2004 (AU) 2004906955

(51) Int. Cl. B65D 69/00; G06Q 30/00; B65D 8/00

(52) U.S. Cl. 206/232; 705/14; 220/669

(57) ABSTRACT

Packaging (20) for a consumable food or drink item, said packaging (20) being adapted to secure said food or drink item therein, wherein a recessed section of an outer peripheral surface of the packaging is shaped to at least partially receive a booklet, whereby the booklet has information unrelated to said packaged item, the information can include news or entertainment items.

### TECHNICAL FIELD OF THE INVENTION

The present invention relates to a packaging for a disposable item.

### BACKGROUND OF THE INVENTION

In recent times, people have become conscious of the health benefits of keeping themselves hydrated. It is not unusual for people to carry around a water bottle to assist them in doing so. Water bottles typically include at least one label bearing the manufacturer's trademark, for example. The labels may also include other information designed to help sell the product, such as a brief blurb on the origins of the contents of the bottle. However, the labels on bottles, and other forms of packaging for disposable items, do not generally make for interesting reading. More particularly, labels typically only include information relevant to the product to which they are attached.

It is desirable to overcome or ameliorate one or more of the above-mentioned difficulties, or at least provide a useful alternative.

### SUMMARY OF THE INVENTION

In accordance with one aspect of the present invention there is provided, packaging for a food or drink item, said packaging being adapted to secure said food or drink item therein, wherein a recessed section of an outer peripheral surface of the packaging is shaped to at least partially receive a booklet.

Preferably, the packaging is generally tubular.

Preferably, the booklet is a magazine.

In accordance with another aspect of the present invention there is provided, packaging for a food or drink item, said packaging being adapted to secure said food or drink item therein, including a substantially tubular body and a hollow receptacle extending into said tubular body, the receptacle being adapted to receive, and seat therein, a booklet.

Preferably, the booklet is a magazine.

In accordance with another aspect of the present invention there is provided, packaging for a food or drink item, said packaging being adapted to secure said food or drink item therein, wherein the packaging includes a booklet coupled thereto.

Preferably, the booklet is coupled to the outer peripheral surface of the packaging by an envelope.

Preferably, the envelope includes a base cover coupled to the outer peripheral surface of the packaging and an outer cover coupled to the base cover so as to secure the booklet therebetween.

Preferably, the base cover includes first and second parts that are adapted to at least partially slide over one another when the envelope is wrapped around the outer peripheral surface of the packaging.

Preferably, the booklet is a magazine.

In accordance with another aspect of the present invention there is provided, in combination, the above-described packaging and a booklet coupled thereto.

Preferably, the booklet is a magazine.

In accordance with another aspect of the present invention there is provided, a process for distributing booklets to retail stores, including the steps of:
(a) coupling said booklets to respective ones of the above-described packaging for the food or drink item; and
(b) distributing said respective ones of the packaging for the food or drink item, each having a booklet coupled thereto, to one or more of said retail stores.

Preferably, the booklets are magazines.

In accordance with another aspect of the present invention there is provided, a system for distributing booklets to retail stores, including the steps of:
(a) coupling said booklets to respective ones of the above-described packaging for the food or drink item; and
(b) distributing said respective ones of the packaging for the food or drink item, each having a booklet coupled thereto, to one or more of said retail stores.

Preferably, the booklets are magazines.

In accordance with another aspect of the present invention there is provided, packaging for a disposable item, said packaging including a predetermined surface area bearing news and/or entertainment items.

In accordance with another aspect of the present invention there is provided, a process for distributing news and/or entertainment items to the public, said process including the step of distributing the above-described packaging.

### BRIEF DESCRIPTION OF THE DRAWINGS

Preferred embodiments of the present invention are hereafter described, by way of non-limiting example only, with reference to the accompanying drawings, in which:

FIG. 1 is a front view of packaging for a disposable item;

FIG. 2 is a plan view of a label for the packaging shown in FIG. 1;

FIG. 3 is a front view of another packaging for a disposable item;

FIG. 4 is a side view of the packaging shown in FIG. 3;

FIG. 5 is a front view of a booklet;

FIG. 6 is a side view of the booklet shown in FIG. 5;

FIG. 7 is a front view of the packaging shown in FIG. 3 coupled to the booklet shown in FIG. 5;

FIG. 8 is a side view of the packaging shown in FIG. 8;

FIG. 9 is a front view of the packaging shown in FIG. 3 coupled to the booklet shown in FIG. 5 by a patch;

FIG. 10 is a side view of the packaging shown in FIG. 3 coupled to the booklet shown in FIG. 5 by a patch;

FIG. 11 is a front view of another packaging for a disposable item;

FIG. 12 is a side view of packaging shown in FIG. 11;

FIG. 13 is a front view of the packaging shown in FIG. 11 coupled to the booklet shown in FIG. 5;

FIG. 14 is a side view of the packaging shown in FIG. 11 the booklet shown in FIG. 5;

FIG. 15 is a front view of packaging for another disposable item;

FIG. 16 is a side view of packaging shown in FIG. 15;

FIG. 17 is a front view of another packaging for a disposable item coupled to a booklet;

FIG. 18 is a side view of packaging shown in FIG. 17;

FIG. 19 is a plan view of the booklet shown in FIG. 17;

FIG. 20 is a front view of another packaging for a disposable item coupled to a booklet;

FIG. 21 is a perspective view of another packaging for a disposable item;

FIG. 22 is a perspective view of a booklet for coupling to the disposable item shown in FIG. 21;

FIG. 23 is a plan view of the booklet shown in FIG. 22;

FIG. 24 is a perspective view of the packaging shown in FIG. 21 coupled to the booklet shown in FIG. 22;

FIG. 25 is a front view of another packaging for a disposable item;

FIG. 26 is a side view of the packaging shown in FIG. 25 coupled to a booklet;

FIG. 27 is a front view of another packaging for a disposable item;

FIG. 28 is a partially exploded view of the packaging shown in FIG. 27;

FIG. 29 is a front view of another packaging for a disposable item;

FIG. 30 is an exploded view of a part of the packaging shown in FIG. 29;

FIG. 31 is a front view of another packaging for a disposable item;

FIG. 32 is a partially exploded view of a part of the packaging shown in FIG. 31;

FIG. 33 is a bottom view of the packaging shown in FIG. 31.

FIG. 34 is a front view of another packaging for a disposable item;

FIG. 35 is a side view of the packaging shown in FIG. 34;

FIG. 36 is a side view of a cover label and a base label of the packaging shown in FIG. 34 with a booklet arranged therebetween;

FIG. 37 is a plan view of the packaging shown in FIG. 34 arranged in another condition of use;

FIG. 38 is a plan view of the base label shown in FIG. 36;

FIG. 39 is a plan view of the base label shown in FIG. 36 arranged in another condition of use;

FIG. 40 is a plan view of the base label shown in FIG. 36 with a booklet arranged thereon;

FIG. 41 is a plan view of the cover label and base label shown in FIG. 36;

FIG. 42 is a flow chart showing the steps performed by the system in manufacturing and distributing bottled water having magazines coupled thereto;

FIG. 43 is a flow chart showing the steps performed by the system in manufacturing and distributing bottled water having magazines coupled thereto;

FIG. 44 is a flow chart showing the steps performed by the system in manufacturing and distributing bottled water having magazines coupled thereto; and

FIG. 45 is a flow chart showing the steps performed by the system in manufacturing and distributing bottled water having magazines coupled thereto.

### DETAILED DESCRIPTION OF PREFERRED EMBODIMENTS OF THE INVENTION

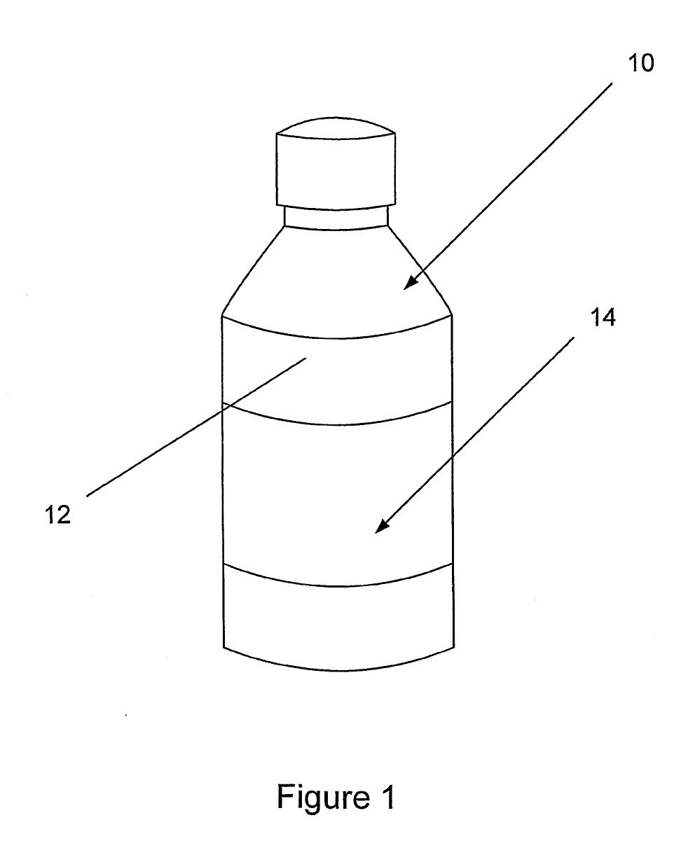

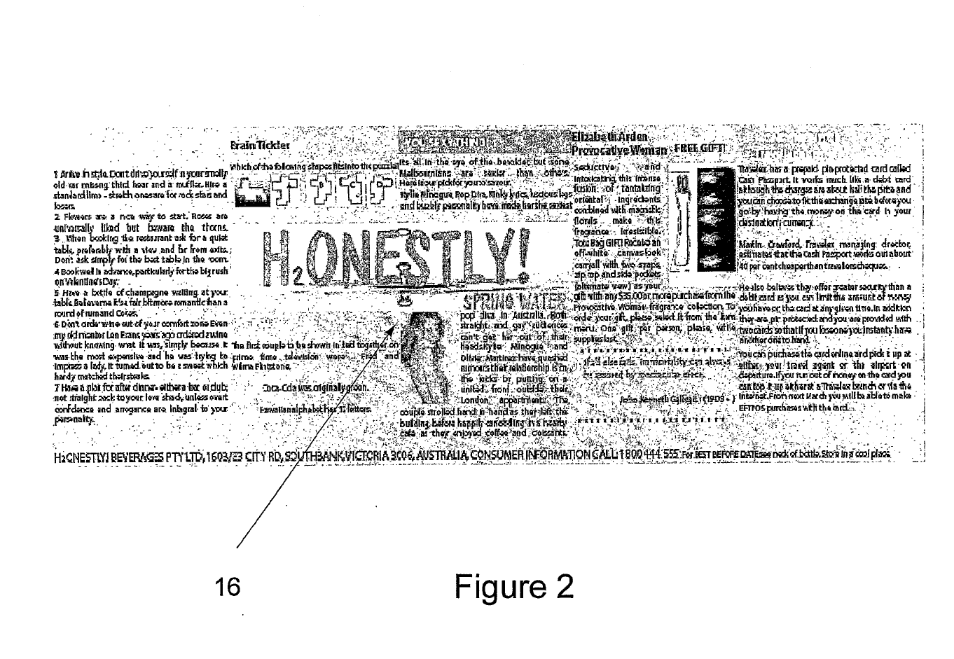

The packaging 10 for the disposable item 12 shown in FIG. 1 is a bottle 10 for carrying water. The packaging 10 includes a label 14 secured to an outer peripheral surface of the bottle 10. The label 14 includes the trade mark of the relevant trader, together with other advertising indicia, and a predetermined surface area 16 bearing entertainment and news items, as shown in FIG. 2.

The news items include a selection of current affairs articles and information on the weather, for example. The news items also may include information on health, money and politics, etc. The items of entertainment include games such as word searches, puzzles etc. The items of entertainment also may include articles on topics of interest, such as biographies on celebrities and historical figures.

The news items are preferably selected to appeal to a particular social demographic in a community. For example, the news items may be directed towards sporting news for males such as cricket, football and the like. The news items may also be directed to current affairs of interest to children or the elderly.

Similarly, the entertainment items are selected to appeal to a particular social demographic in a community. For example, the items of entertainment are directed towards people who are interested in poetry, or movies. The items of entertainment may also be directed to new recipes, dating and health tips, etc.

Advantageously, the supply of the above-described bottle 10 into the community distributes news and entertainment in to the community. In particular, the supply of the bottle 10 to retail stores disseminates news and entertainment items into the community.

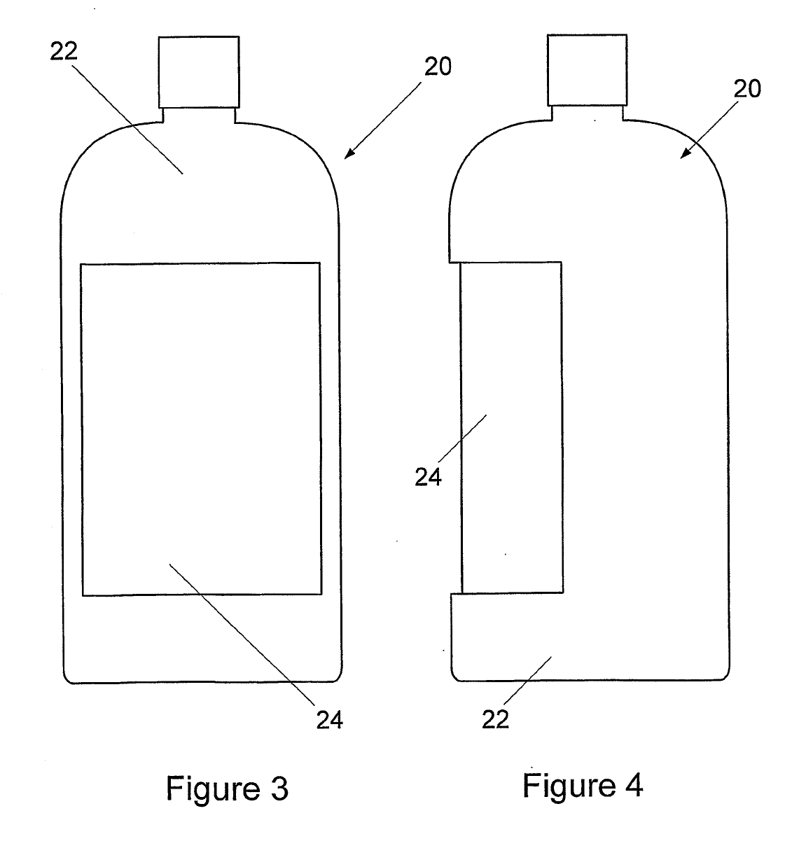

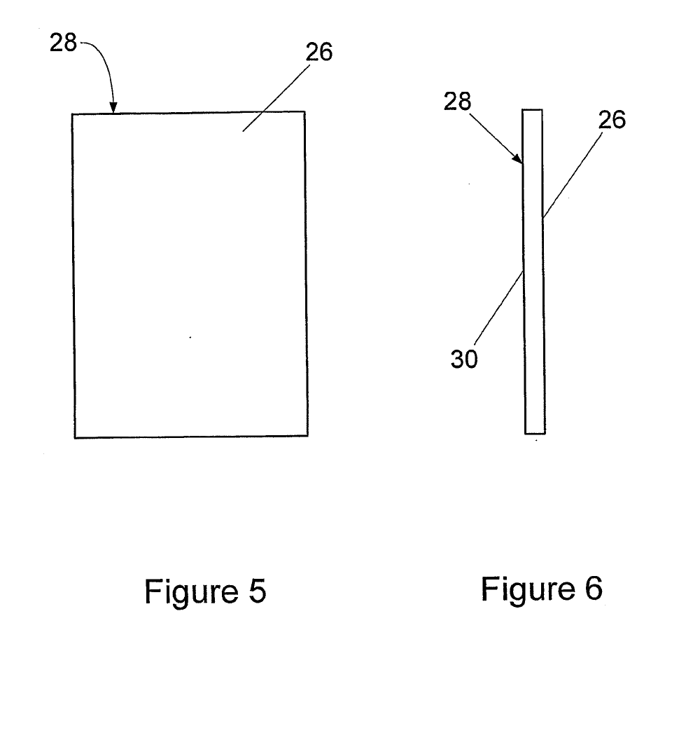

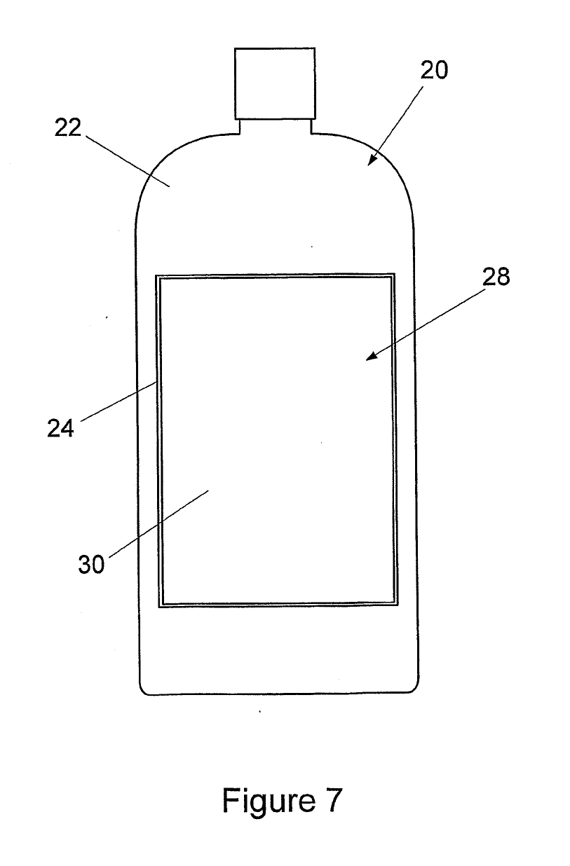

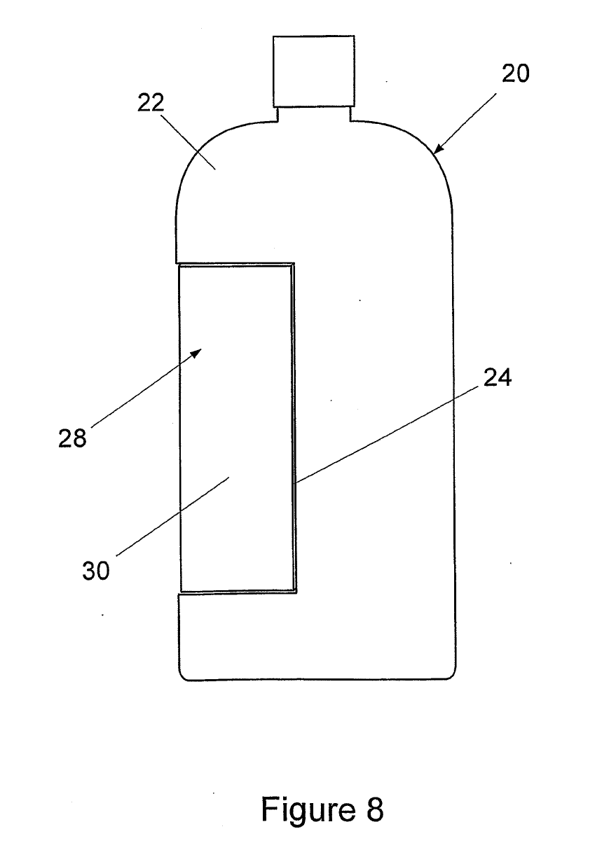

The packaging 20 for the disposable item 22 shown in FIGS. 3 and 4 is a generally cylindrical bottle 20 suitable for carrying water, for example. The packaging 20 could, alternatively, be the primary packaging of grocery items within Tetra Paks, confectionery wrapping, aluminium cans and cardboard boxes, for example. An outer peripheral side section of the packaging 20 includes a recess 24 that is shaped to at least partially receive a back side 26 of the booklet 28 shown in FIGS. 5 and 6. A front side 30 of the booklet 28 is generally coplanar with the outer peripheral surface of the packaging 20 when the booklet 28 is seated in the recess 24, for example. Alternatively, the front side 30 of the booklet 28 lies adjacent the outer peripheral surface of the packaging 20 when the booklet 28 is seated in the recess 24 in the manner shown in FIGS. 7 and 8.

The booklet 28 is preferably a magazine 28, or a book 28, or any other suitable means for bearing entertainment and/or news items such as a card. The term “booklet” is used hereafter to include a book, magazine, card and any other suitable device for bearing literary works, entertainment items news items, etc. The booklet 28 is preferably made of a flexible material that can bend to conform to the shape of the outer peripheral surface of the bottle 20.

The booklet 28 is coupled to the packaging of the bottle by an adhesive (not shown). The adhesive preferably permits the booklet to be removably coupled to bottle 20.

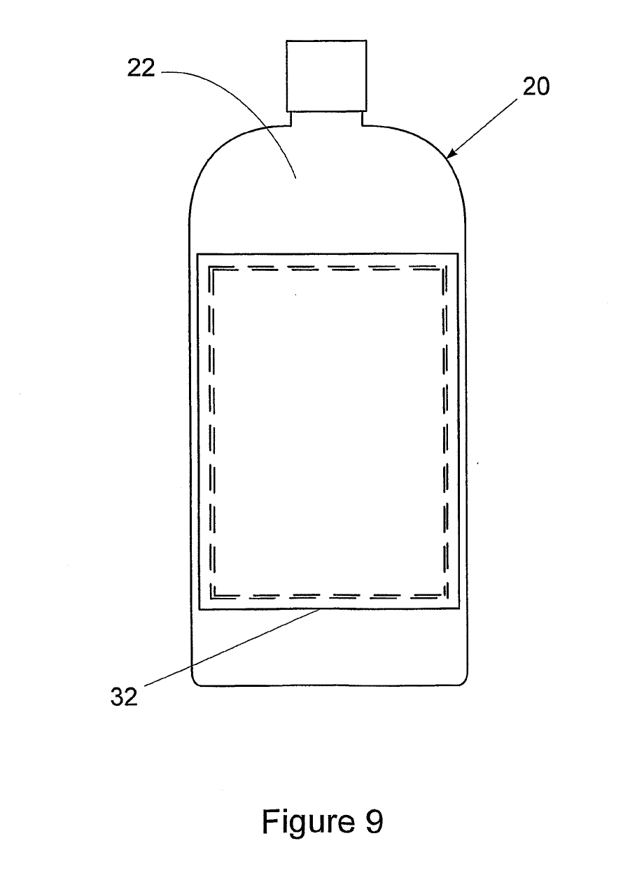

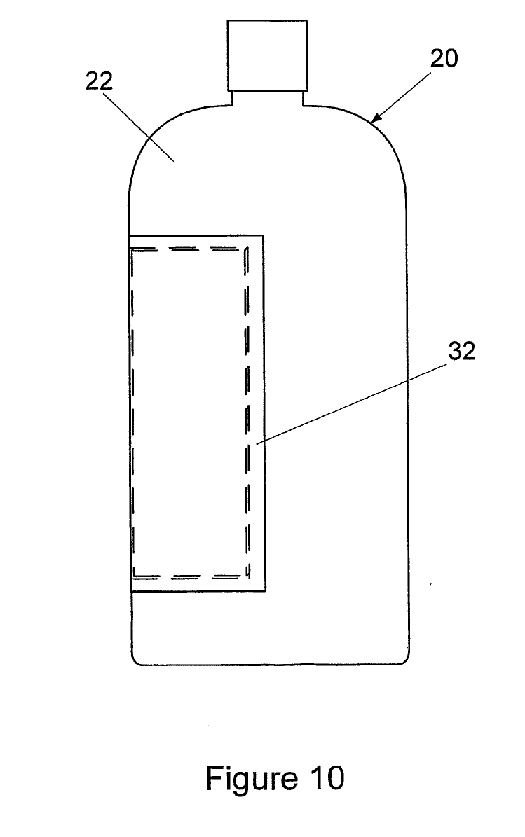

The booklet 28 is alternatively coupled to the bottle by the removable patch 32 shown in FIGS. 9 and 10. The patch 32 is shaped to overlie and cover the recess 24 and, when so arranged, secures the booklet 28 in a position seated in the recess 24. The patch 32 is preferably removably coupled to the bottle 20 by an adhesive. However, the patch 32 can be coupled to the bottle 20 by any other suitable means.

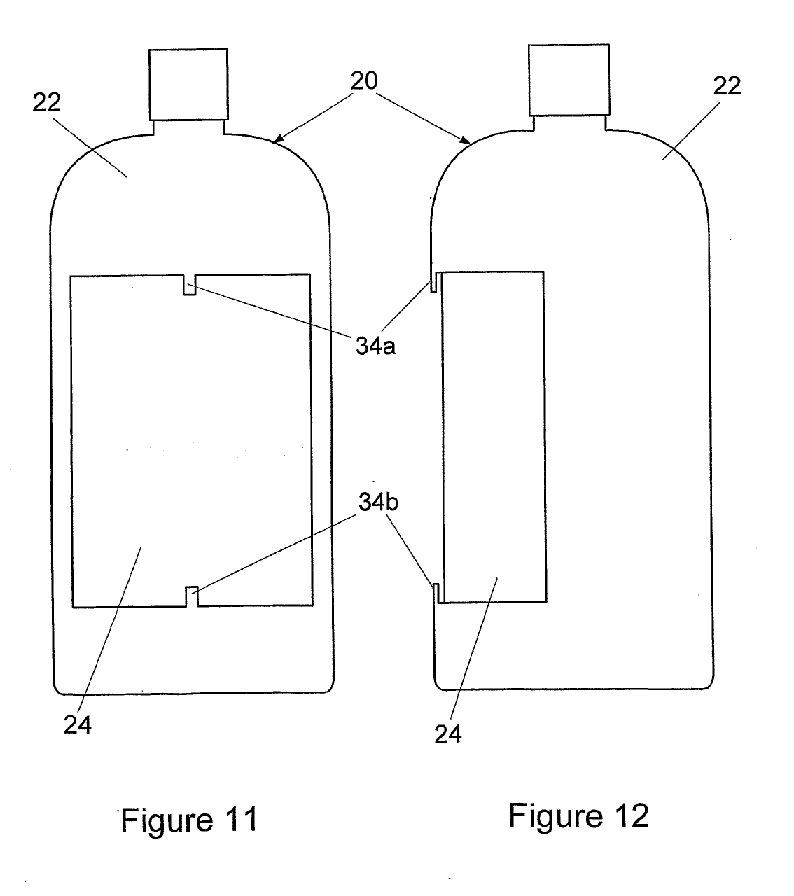

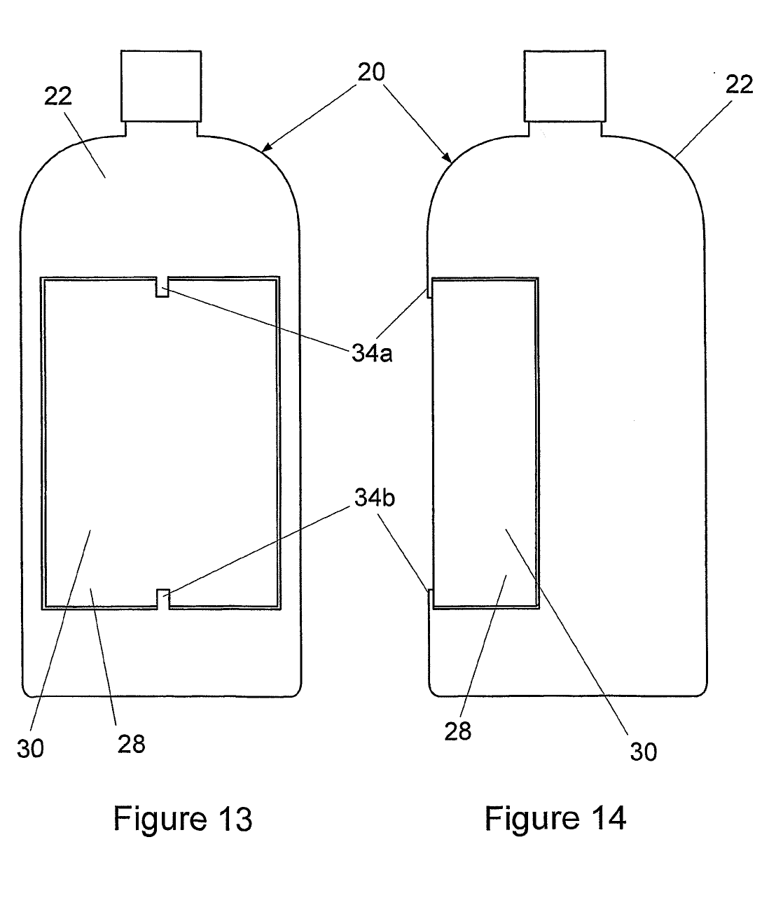

Alternatively, the booklet is coupled to the bottle upper and lower lugs 34a,34b that extend towards each other from opposite sides of the recess 24, as shown in FIGS. 11 and 12. When the booklet 28 is seated in the recess 24, the lugs 34a,34b extend over the front side 30 of the booklet 28 and retain the booklet 28 in a seated position, in the manner shown in FIGS. 13 and 14. The bottle 20 can include additional/alternative lugs (not shown) that extend towards each other from other sides of the recess 24.

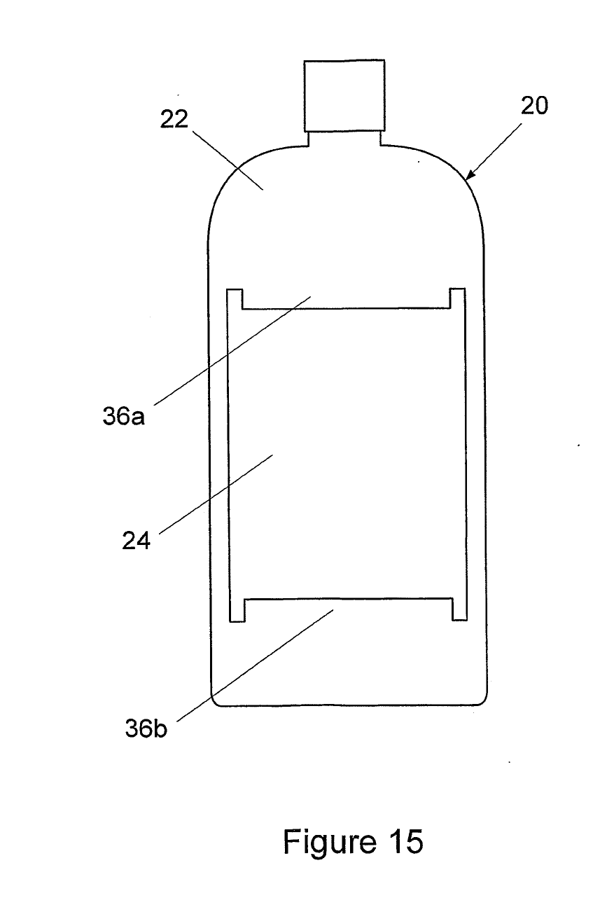

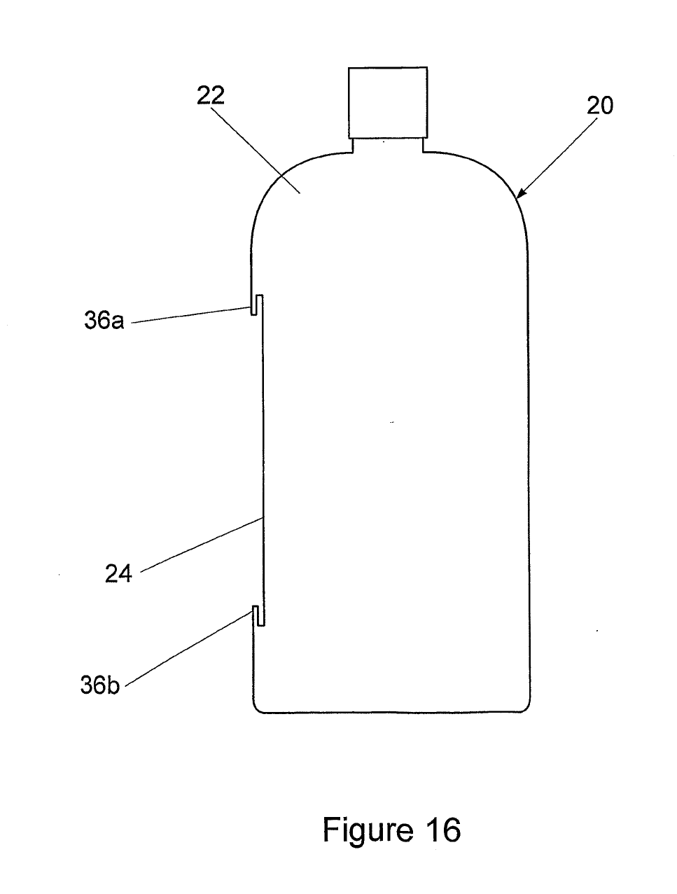

The bottle 20 shown in FIGS. 15 and 16 includes alternative upper and lower lugs 36a,36b for coupling the booklet 28 to the bottle 10. The upper and lower lugs 36a,36b extend towards each other from opposite sides of the recess 24. The lugs 36a,36b extend across the width their respective ends of the of the recess 24. The booklet 28 is coupled to the bottle 20 by inserting a first end of the booklet 28 into a gap defined by the upper lug 36a overhanging the recess 24, and then inserting a second end of the booklet 28 into a gap defined by the lower lug 36b overhanging the recess 24. When the booklet 28 is seated in the recess 24 in the described manner, the lugs 36a,36b extend over the front side 30 of the booklet 28 and retain the booklet 28 in a seated position. The bottle 20 can include additional/alternative lugs (not shown) that extend towards each other from other sides of the recess 24.

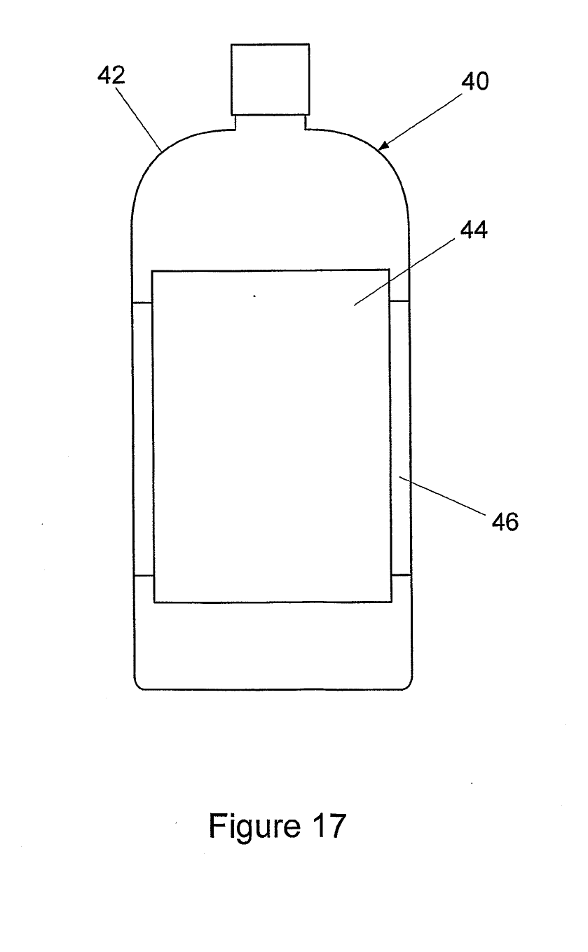

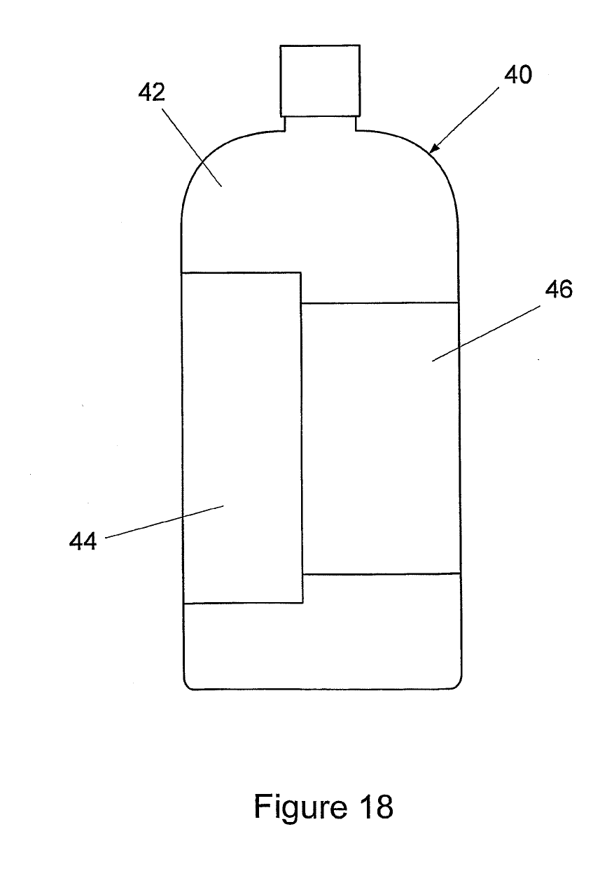

The packaging 40 for the disposable item 42 shown in FIGS. 17 and 18 is a generally cylindrical bottle 40 suitable for carrying water, for example. The packaging 40 could, alternatively, be the primary packaging of grocery items within Tetra Paks, confectionery wrapping, aluminium cans and cardboard boxes, for example. The bottle 40 includes a booklet 44 coupled to one side thereof by a band 46 that extends around the periphery of the cylindrical body of the bottle 40.

The booklet 44 is preferably a magazine, or book, or any other suitable means for bearing entertainment and/or news items such as a card 44. The term “booklet” is intended to include a book, magazine, card or any other suitable device for bearing literary works, entertainment items news items, etc. The booklet 44 is preferably made of a flexible material that can bend to conform to the shape of the bottle 40.

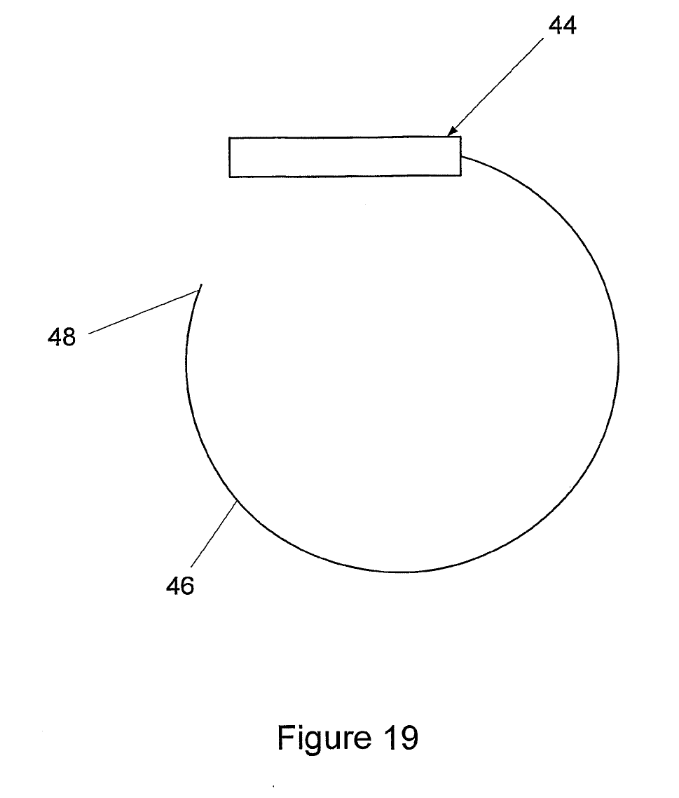

The band 46 is preferably made of a plastic material that can be wrapped around the tubular body of bottle 40. The band 46 is preferably fastened to the bottle 40 by an adhesive, for example. The booklet 44 can be detached from the bottle 40 by breaking the band 46, as shown in FIG. 19.

Alternatively, the band 46 is made of an elastically resilient material that can be resiliently stretched over the neck of the bottle 40 and arranged around the waist of the cylindrical body of the bottle 40. In this embodiment, the booklet 44 is coupled to the band 46 by an adhesive. The booklet 44 can be detached from the bottle 40 by resiliently expanding the band 46 and drawing it back over the neck of the bottle 40. Otherwise, the booklet 44 can be detached from the bottle 40 by breaking the band 46.

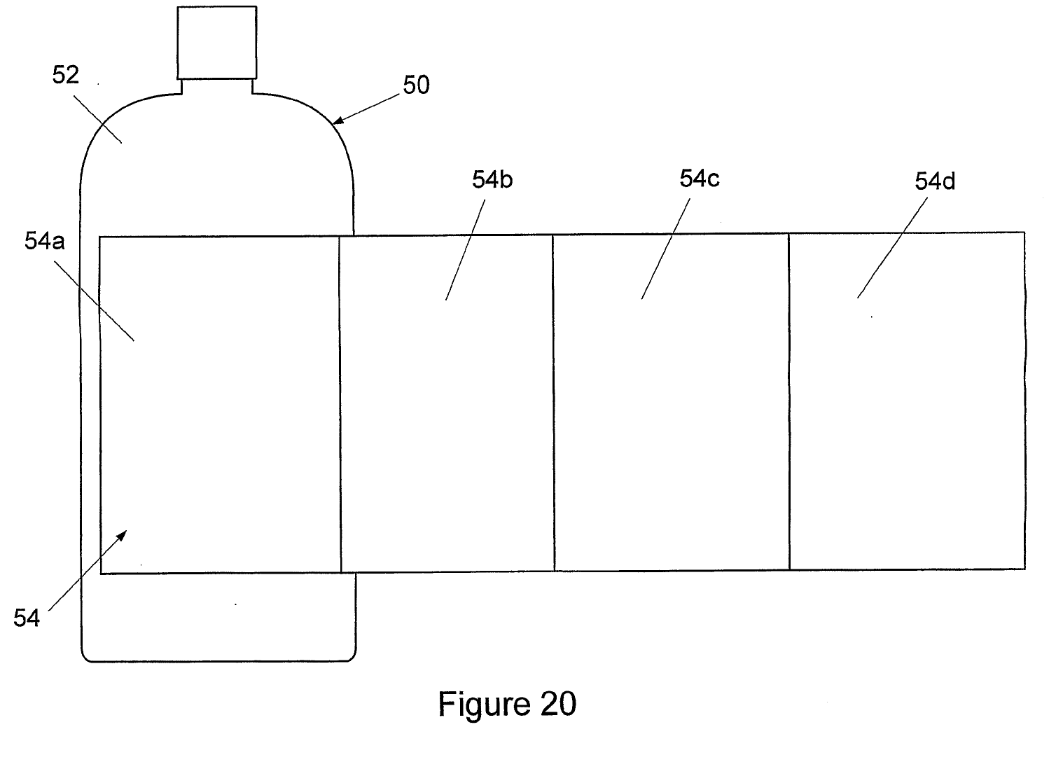

The packaging 50 for the disposable item 52 shown in FIG. 20 is a generally cylindrical bottle 50 suitable for carrying water, for example. The packaging 50 could, alternatively, be the primary packaging of grocery items within Tetra Paks, confectionery wrapping, aluminium cans and cardboard boxes, for example. The bottle 50 includes a booklet 54 coupled to one side thereof by a suitable adhesive, for example.

The booklet 54 is a generally rectangular sheet of material that includes a series of panels, each being separated by a longitudinal crease in the material. The first panel 54a is coupled to a side of the bottle 50 by an adhesive, for example. In a closed condition of use, the second panel 54b is folded back over the first panel 54a; the third panel 54c is folded back over the second panel 54b; and the fourth panel 54d is folded back over the third panel 54c. When so arranged, the panels 56 overlie one another and can be secured in that position by a fastener, such as an adhesive.

In the expanded condition of use shown in FIG. 20, the panels 54a,54b,54c,54d of the booklet 54 are arranged so that the literature which they bear can be read by a person. In this arrangement, all panels except for the first panel 54a can bear literature on both sides.

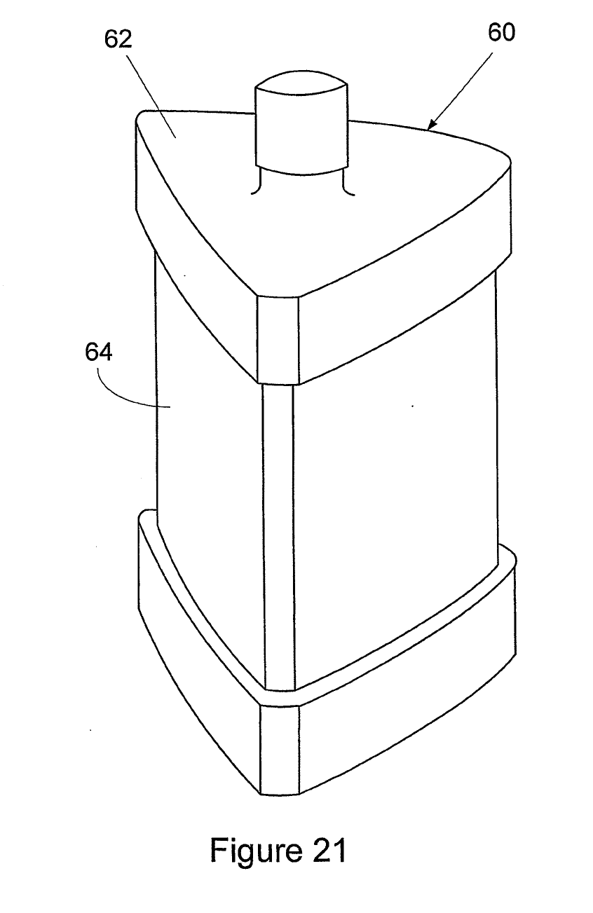

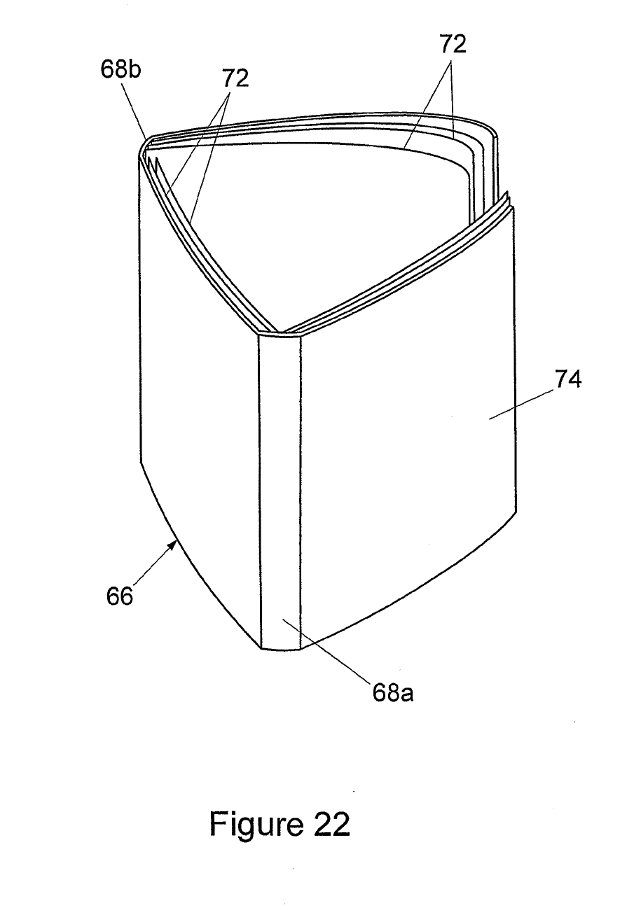

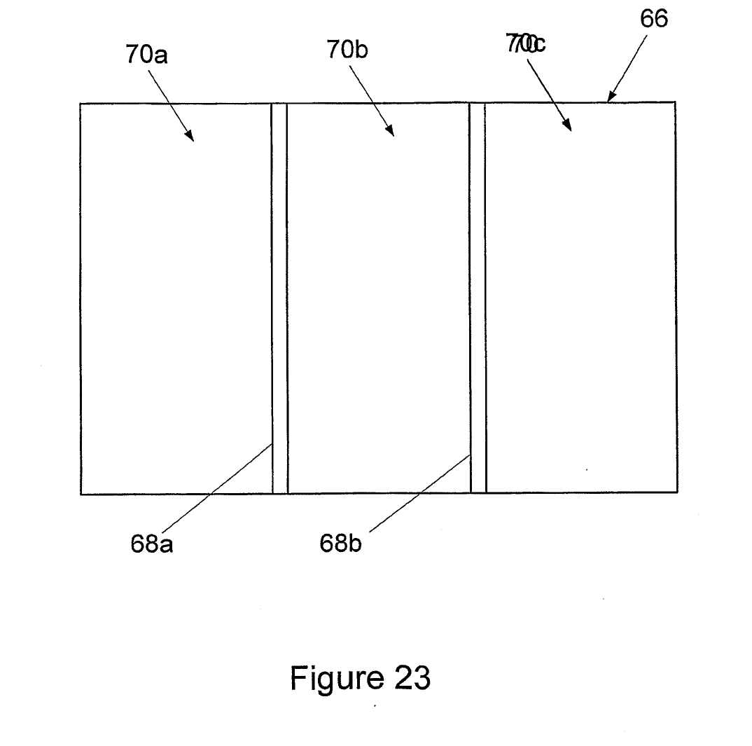

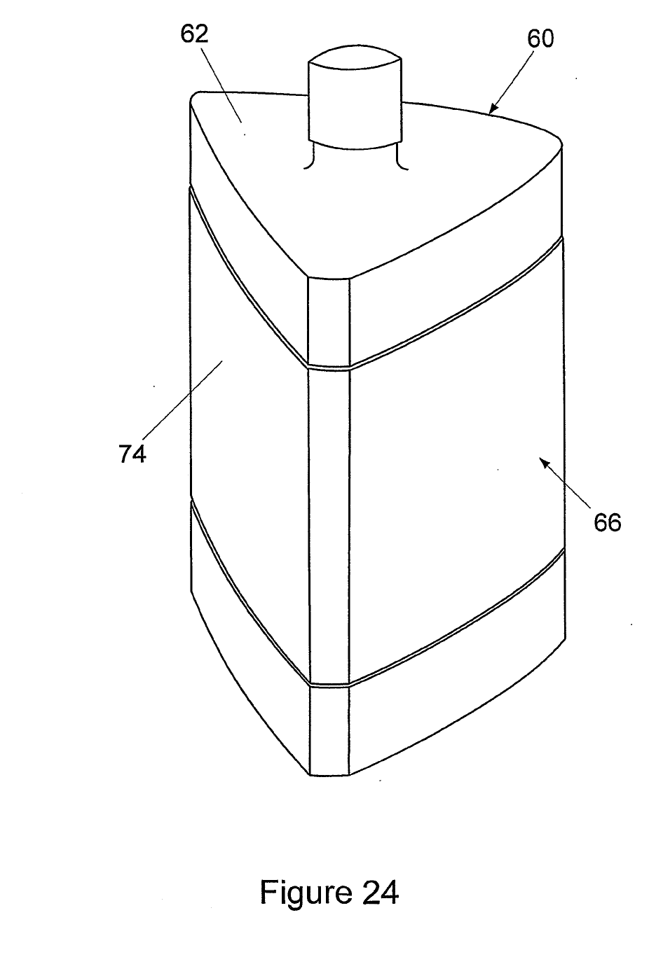

The packaging 60 for the disposable item 62 shown in FIG. 21 is a tubular bottle 60 of triangular cross-section suitable for carrying water or fruit juice, for example. The packaging 60 could, alternatively, be the primary packaging of grocery items within Tetra Paks, confectionery wrapping, aluminium cans and cardboard boxes, for example. An outer peripheral side section of the packaging 20 includes a recess 64 that is shaped to at least partially receive the booklet 66 shown in FIGS. 22 and 23 in the manner shown in FIG. 24.

The booklet 66 is preferably a magazine 66, or any other suitable means for bearing literature such as a card. The booklet 66 include three panels 70a,70b,70c, each being separated by a longitudinal spine 68a,68b. The panels 70a,70b,70c each include a plurality of associated pages 72 of literature, such as news items and entertainment items. The two spines 68a,68b permit the booklet 66 to be arranged in a generally triangular shape so as to be seated in the recess 64 of the bottle 60 in the manner shown in FIG. 24. When so arranged, the outer cover 74 of the booklet 66 is generally coplanar with the outer peripheral surface of the packaging 60, for example. Alternatively, the outer cover 74 of the booklet 66 lies parallel to the outer peripheral surface of the packaging 60 when the booklet 64 is seated in the recess 64 in the manner shown in FIG. 24.

The booklet 66 is coupled to the bottle 60 using an adhesive. Alternatively, the booklet may be coupled to the bottle 60 by plastic wrapped around the outer peripheral surface of the bottle, or by any other suitable means.

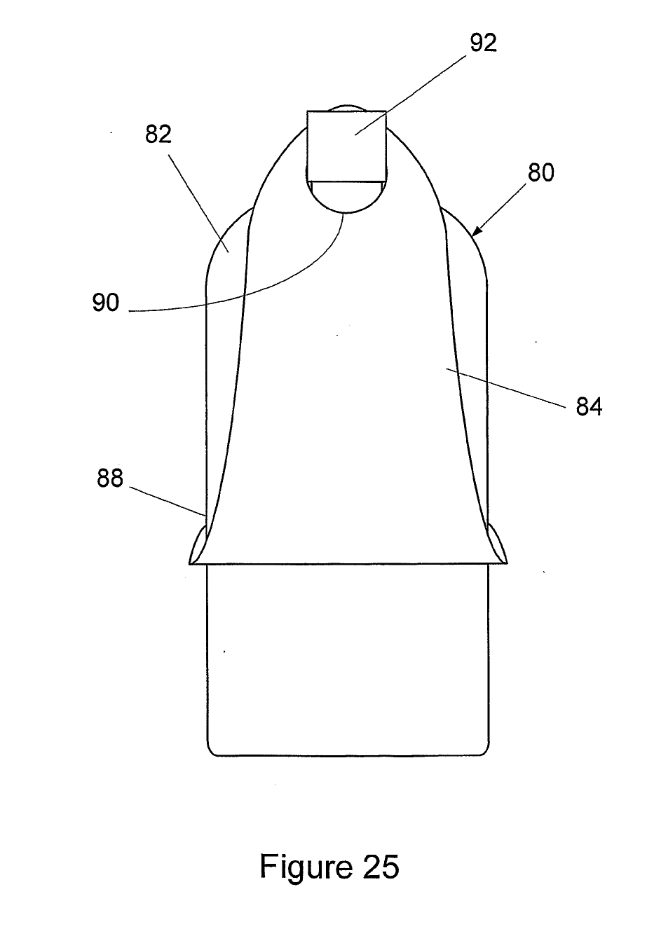

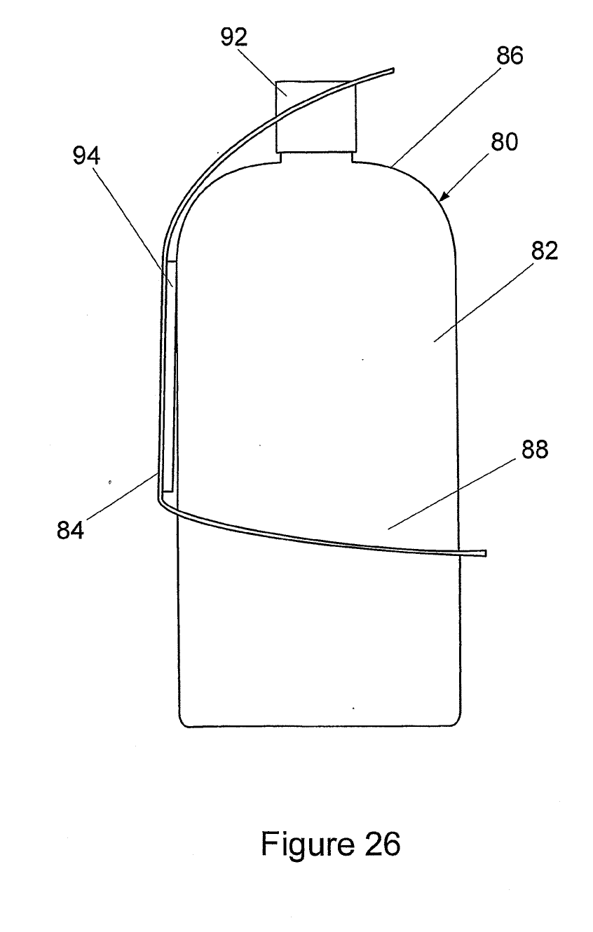

The packaging 80 for the disposable item 82 shown in FIGS. 25 and 26 is a bottle 80 suitable for carrying water or fruit juice, for example. The bottle 80 includes a bib 84 that extends from the neck 86 to the waist 88 of the bottle 80. An upper section of the bib 84 includes an aperture 90 of suitable size to fit over the lid 92 of the bottle 80. The bib 84 is adapted to hang from the neck 86 of the bottle 80 when the upper section of the bib 84 is arranged in the described manner. A lower section of the bib 84 also includes an aperture (not shown) of suitable size to pass over the cylindrical body of the bottle 80. The bib 84 can be fitted to the bottle by passing the neck 86 of the bottle 80 through the aperture of the lower section and then sliding said lower section of the bib down the body of the bottle 80 until it sits around the waist 88 of the bottle 80. When so arranged, the aperture 90 of the upper section of the bottle 80 can then be arranged over the lid 92.

An underside of the bib 84, ie the side overlying the outer peripheral surface of the bottle 80, includes a booklet 94 coupled thereto. The booklet 94 is preferably coupled to the bib 84 by an adhesive. However, the booklet 94 could otherwise be coupled to the bib 84 by any other suitable means. The booklet 94 is preferably a magazine 90, or any other suitable means for bearing a collection of literary works, such as news items, entertainment items, etc.

The booklet 94 can be accessed by tearing the bib 84 from the bottle 80, or by sliding the bib 84 back up and over the neck of the bottle 80.

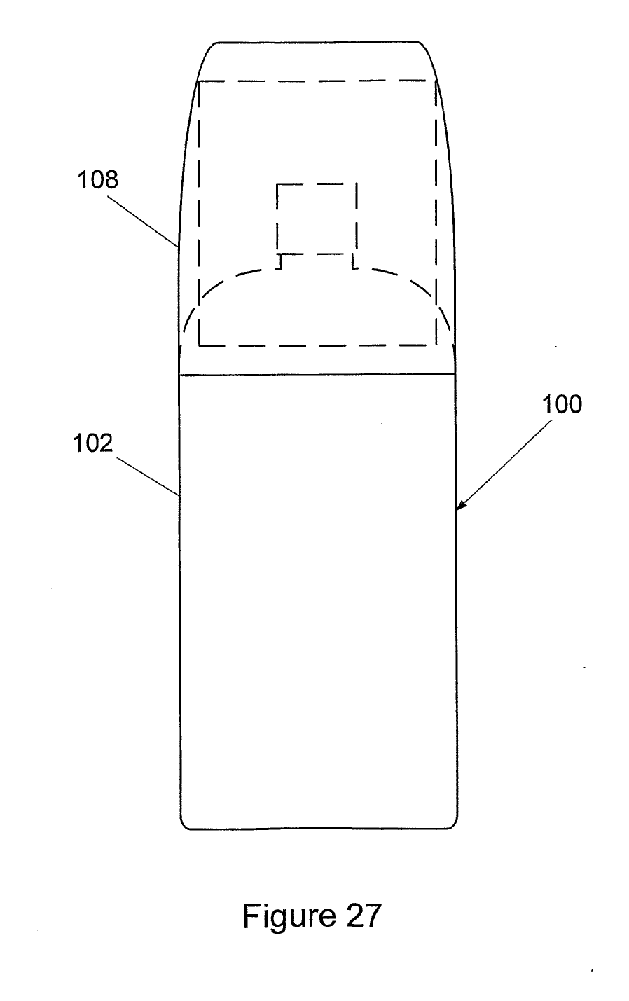

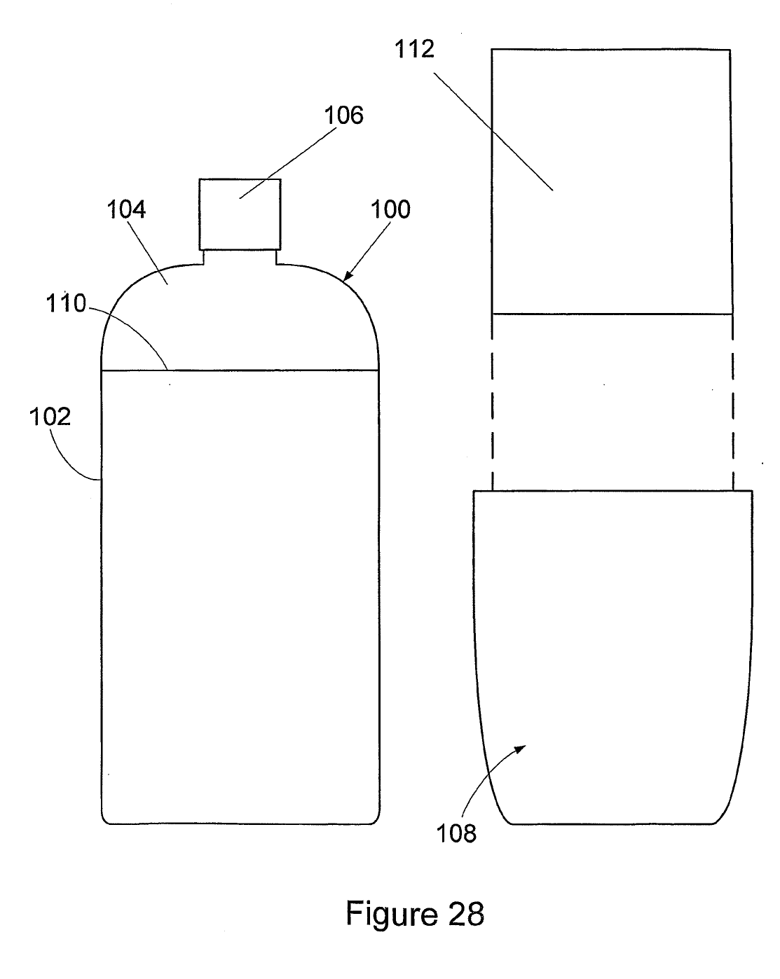

The packaging 100 for the disposable item 102 shown in FIGS. 27 and 28 is a bottle 100, for example, suitable for carrying water, soft drink, or other food item. The neck 104 of the bottle 100 includes a lid 106 that is adapted to be selectively coupled to an opening of the bottle 100. The lid 106 is coupled to the bottle 100 by a screw thread, for example.

The bottle 100 includes a cup 108 that can be fitted over the neck 104 of the bottle 100 and later used as a drinking receptacle. The cup 108 preferably includes one or more raised protrusions (not shown) on the inner side of its rim that is shaped to engage a corresponding recess 110 formed around the outer peripheral surface of the neck 104 of the bottle 100. The protrusions are positioned so as to be seated in the recess 110 when the cup 108 is fitted to the bottle 100 in the described manner. The cup 108 is thereby secured to the bottle 100. Alternatively, the cup 108 may be secured to the bottle by any other suitable means.

The cup 108 includes a booklet 112 seated therein. The booklet 112 is preferably a magazine 112. The magazine 112 is coupled to the bottle 100 when the cup 108 is fitted to the bottle 100 in the above-described manner.

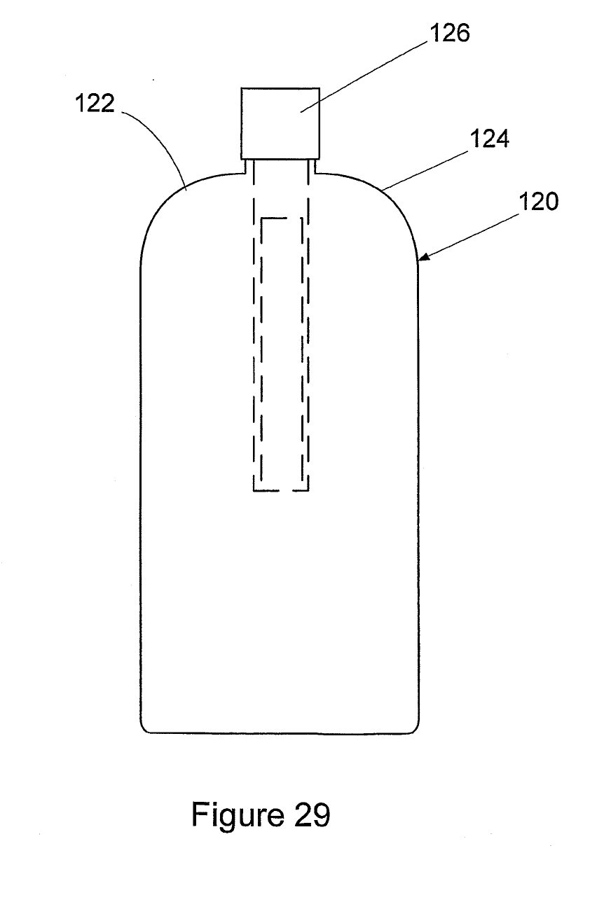

The packaging 120 for the disposable item 122 shown in FIG. 29 is a bottle 120, for example, suitable for carrying water, soft drink, or other food item. The neck 124 of the bottle 120 includes a lid 126 that is adapted to be selectively coupled to an opening of the bottle 120. The lid 126 is coupled to the bottle by a screw thread, for example.

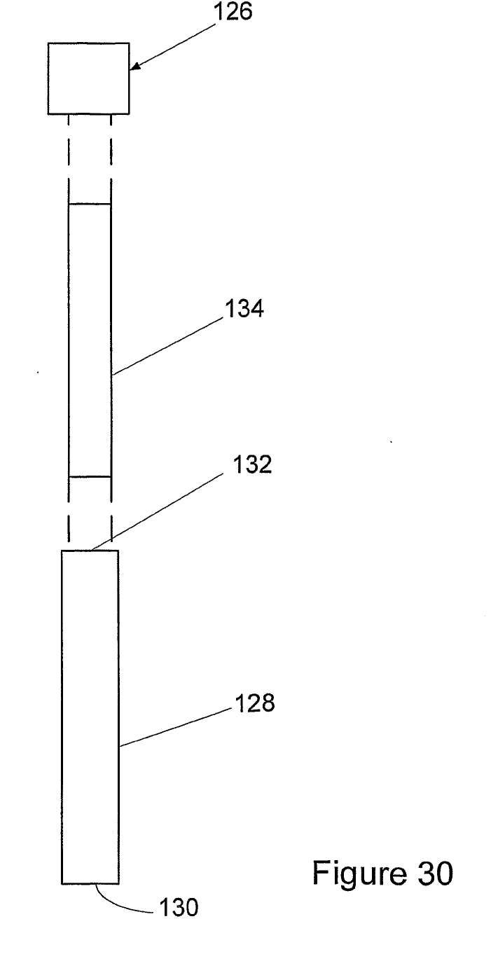

The lid 126 includes a tubular member 128, as shown in FIG. 30, that is closed at one end 130 and open at another 132. The open end 132 tubular member 128 is adapted to be coupled to an underside of the lid 126 in such a way that when the lid 126 engages the screw thread and closes the bottle 120, the tubular member 128 extends downwardly into the bottle 120. The tubular member 128 can be accessed by unscrewing the lid 126 and drawing the member 128 out of the bottle 120.

The tubular member 128 is adapted to receive a booklet 134 through its open end 132 so that the booklet can be entirely seated in the tubular member 128. The booklet 134 is preferably rolled along a longitudinal axis into a cylindrical shape for insertion into the tubular member 128. Once inserted in this manner, the tubular member can be coupled to the lid 126 and the lid can then be coupled to the bottle 120 by the screw thread. The booklet 134 is thereby coupled to the bottle 120. When arranged in the above-described manner, the tubular member 128 preferably prevents the booklet 134 from being tainted by the contents of the bottle 120.

The booklet 134 is distributed to consumers through the sale of bottled water, for example. The booklet 134 can be accessed by performing the following steps:
a. purchasing the bottle 120 from a shop or store;
b. unscrewing the lid 126;
c. drawing the tubular member 128 out of the bottle 120;
d. separating the lid 126 and the open end 132 of the tubular member 128; and
e. drawing out the booklet 134 from the open end 132 of the tubular member 128.

The booklet 134 is preferably a magazine 134 that includes a collection of literary works such as news items, entertainment items, games etc.

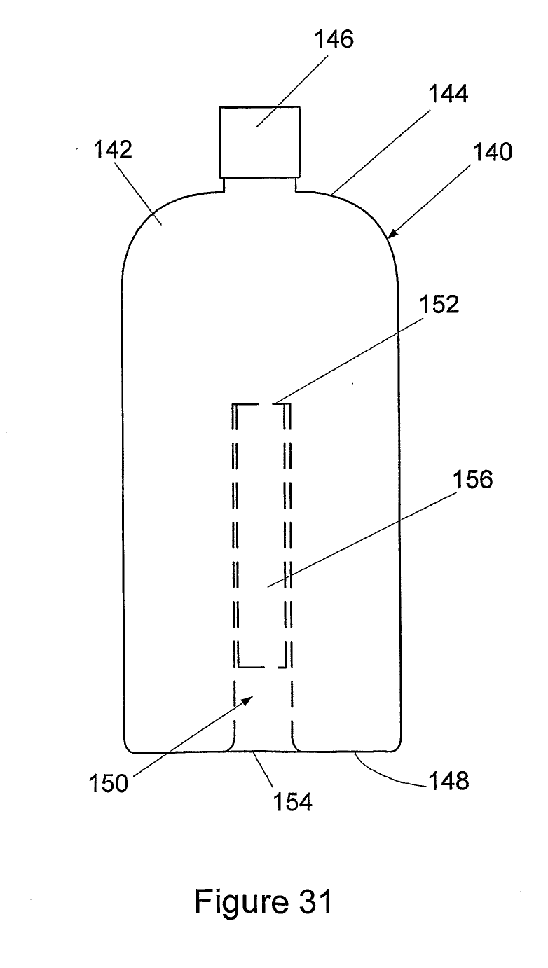

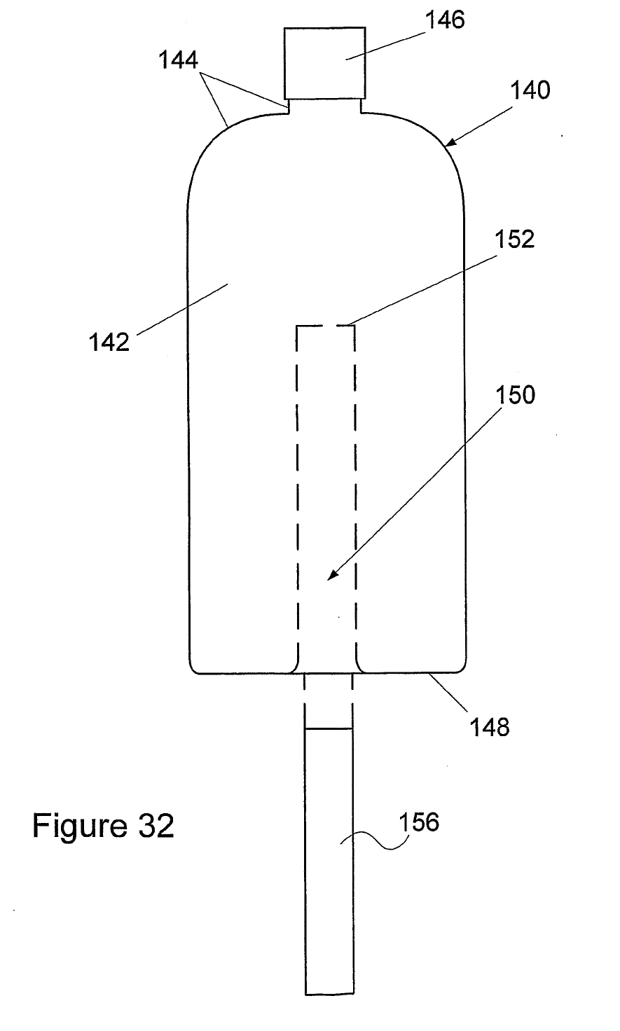

The packaging 140 for the disposable item 142 shown in FIGS. 31 and 32 is a bottle 140, for example, suitable for carrying water, soft drink, or other food item. The neck 144 of the bottle 140 includes a lid 146 that is adapted to be selectively coupled to an opening of the bottle 140. The lid 146 is coupled to the bottle by a screw thread, for example.

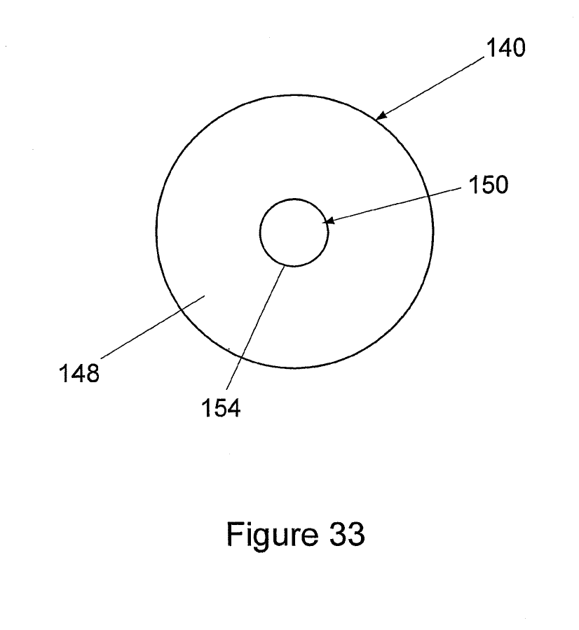

A bottom section 148 of the bottle 140 includes a recess 150 that extends upwardly into the bottle 140 from the bottom section 148 towards the lid 146. The recess 150 is a tubular receptacle that is closed at a top end 152 and open at the bottom end 154, as shown in FIG. 33. The recess 150 is adapted to receive an end of a booklet 156 through the bottom end 154 so that the booklet 156 can be inserted into the bottle 140. The booklet 156 is preferably rolled along a longitudinal axis into a cylindrical shape for insertion into the recess 150. Once inserted in this manner, the booklet 156 preferably resiliently expands and bears against the walls of the recess 150 and is there by coupled to the bottle 140.

The booklet 156 can be acquired by purchasing the bottle 140 from a shop or store and then drawing out the booklet 156 from the open end 154 of the recess 150.

The term “booklet” 156 is intended to include a collection of literary works such as news items, entertainment items, games etc presented on one of more pages of a book or card. The booklet 156 is preferably a magazine.

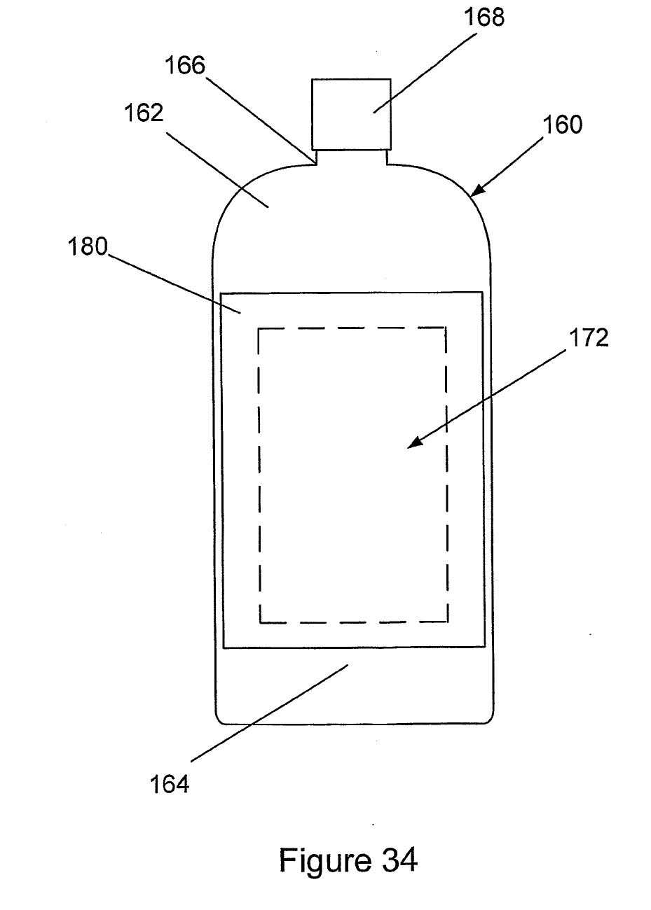

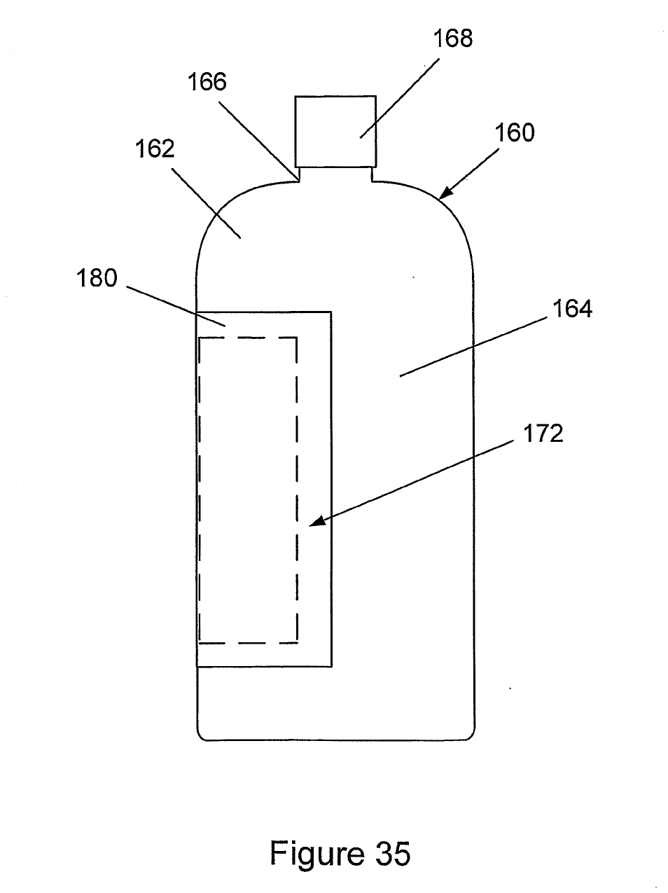

The packaging 160 for the disposable food or drink item 162 shown in FIGS. 34 and 35 is a bottle 160, for example, suitable for carrying water, soft drink, or other food or drink item. The packaging 160 could, alternatively, be the primary packaging of grocery items within Tetra Paks, confectionery wrapping, aluminium cans and cardboard boxes, for example. The bottle 160 includes a generally tubular body 164 having a neck 166 extending from an upper section thereof. The bottle 160 includes a lid 168 that is adapted to be selectively coupled to an opening (not shown) of the neck 166 of the bottle 160. The lid 168 is coupled to the bottle 160 by a screw thread, for example.

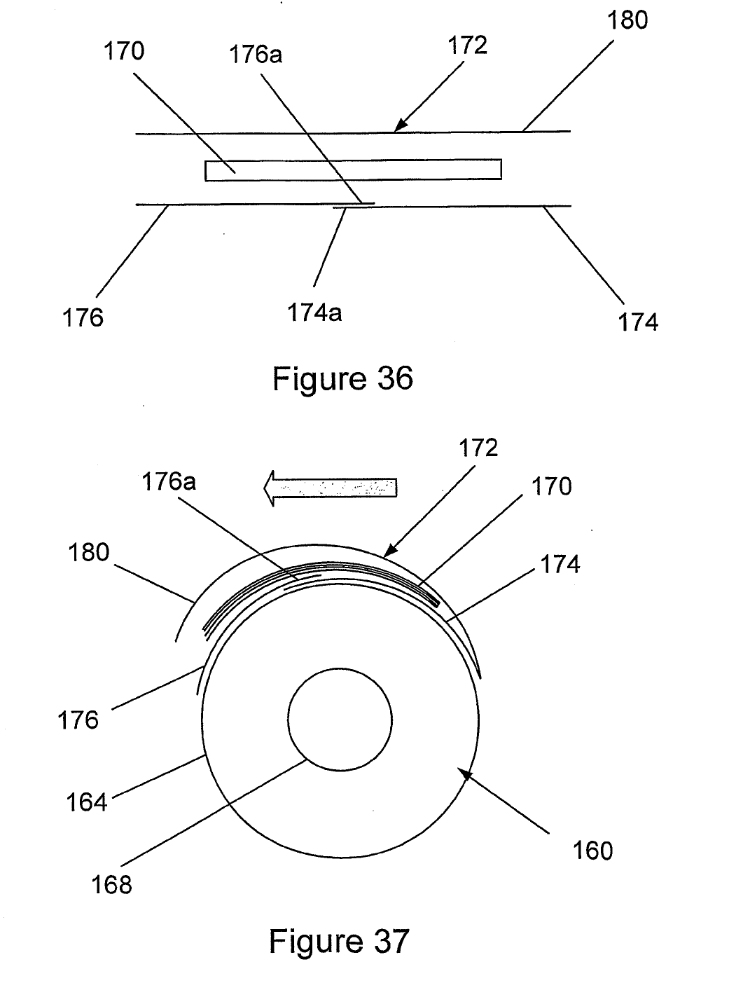

The packaging 160 includes a booklet 170 coupled to the outer peripheral surface of the tubular body 164 of the bottle 160 by label laminate 172, for example, in the manner shown in FIGS. 36 and 37. The booklet is preferably a magazine 170. Alternatively, the booklet 170 can be any other suitable means for bearing one of more literary works. The label laminate 172 is, alternatively, any other suitable envelope for coupling the booklet 170 to the bottle 160.

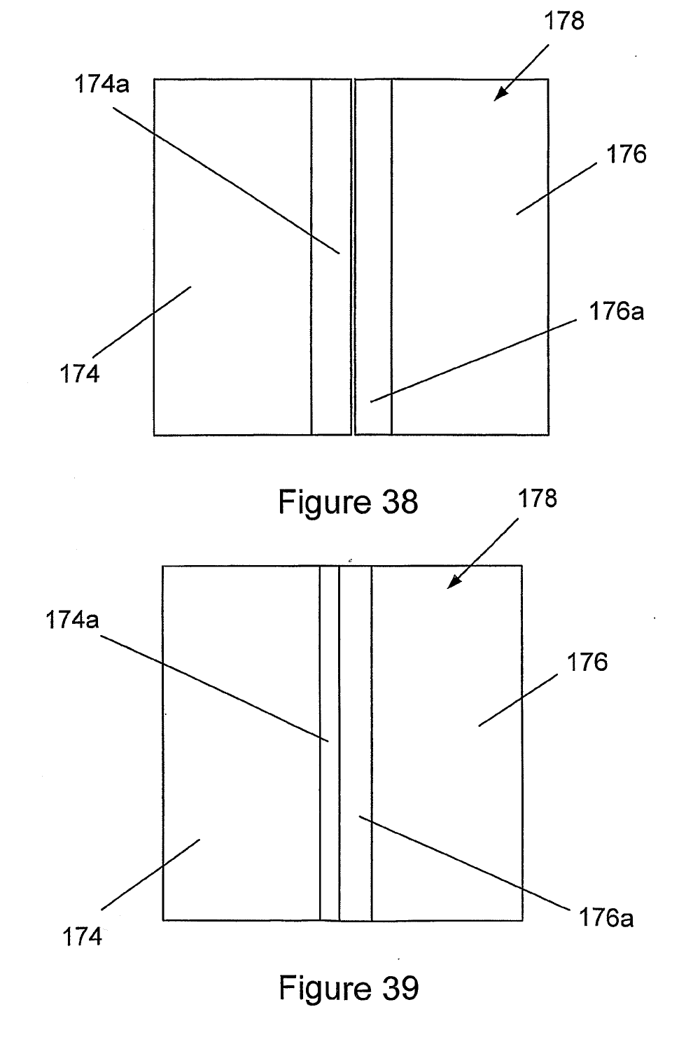

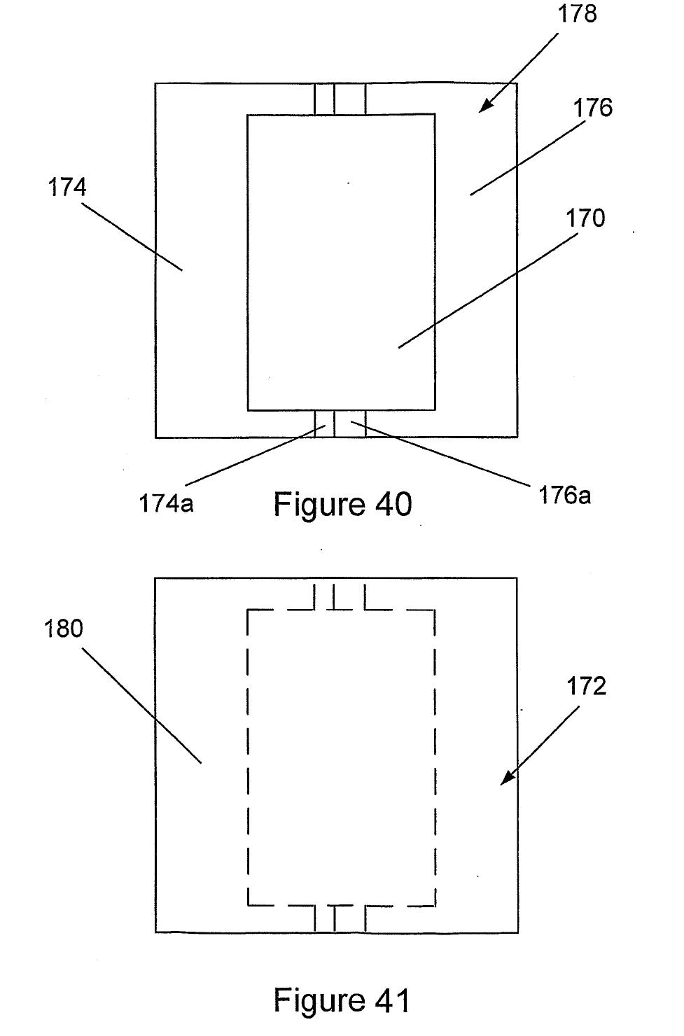

The steps involved in coupling the booklet to the bottle 160 are set out below:
a. Generally rectangular first and second parts 174,176 of a base label laminate 178 are arranged side by side, as shown in FIG. 38;
b. A non-laminate section 176a of the first part 176 of the base label laminate 178 is arranged so as to partially overlie a non-laminate section 174a of the second part 174 of the base label laminate 178, as shown in FIG. 39;
c. The booklet 170 is arranged centrally over the first and second parts 174,176 of the base label laminate 178, as shown in FIG. 40;
d. A cover label 180 is arranged over the base label laminate 178 and the booklet 170, as shown in FIG. 41; and
e. The label laminate 172, with the booklet enclosed therein, is rolled over the tubular body 164 of the bottle 160.

The step of rolling the label laminate 172 over the tubular body 164 of the bottle 160 includes the step of coupling the base laminate 178 to the bottle by way of a fastener, such as an adhesive, for example. The step of rolling the label laminate 172 over the tubular body 164 also includes the step of sealing the cover label laminate 180 to the base label laminate 178. The booklet 170 is thereby sealed in a laminate envelope that is coupled to the outer peripheral section of the tubular body 164 of the bottle. As the label laminate 172 rolls across the outer peripheral surface of the generally cylindrical tubular body 164 of the bottle 160, the non-laminated section 174a of the second part 174 of the base label laminate 178 slides under the non-laminated section 176a of the first part 176 of the base label laminate 178. In doing so, the base label laminate 178 tends not to gather and bunch up as it is rolled around the cylindrical surface of the tubular body 164 of the bottle 160. This kind of crumpling typically occurs when two parallel sheets of material are wrapped around a curved surface.

When the booklet 170 is rolled around the tubular body of the bottle 160 in the above-described manner, it has a tendency resiliently restore itself back to its original flat lying shape. This tendency is known as “spring back”. The fastener that couples the cover label laminate 180 to the base label laminate 178 is preferably strong enough to prevent separation of the cover and base label laminates 180,178 and thereby hold the booklet in place. The fastener is preferably weak enough so that the cover and base label laminates 180,178 can be separated by hand so that the booklet can be accessed. The booklet 170 is preferably a 32 page magazine 170.

In an alternative embodiment, the above-described method steps involved in coupling the booklet 170 the step of arranging the non-laminate section 176a of the first part 176 to overlie the non-laminate section 174a of the second part 174 of the base label laminate 178 is omitted. In this embodiment, the non-laminated section 174a of the second part 174 slides under the non-laminated section 176a of the first part 176 of the base label laminate 178 as the label laminate 172 rolls across the outer peripheral surface of the generally cylindrical tubular body 164 of the bottle 160.

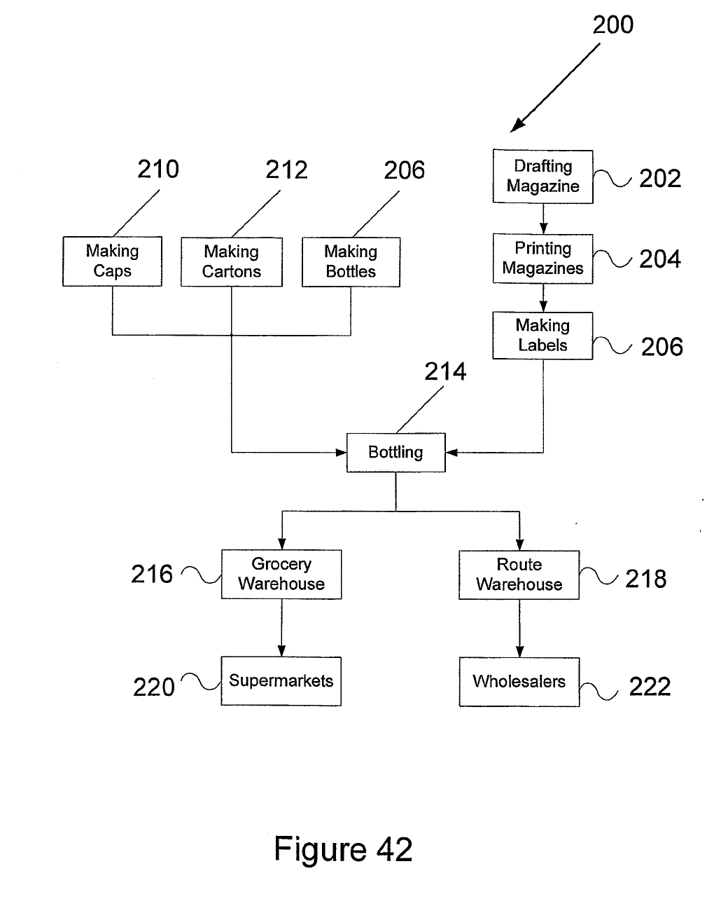

The system 200 shown in FIG. 42 includes exemplary steps involved in the manufacture and distribution of bottled water, for example, having magazines coupled thereto. The system 200 is shown by way of non-limiting example with reference to bottled water and magazines. However, the system 200 is equally applicable to any other packaging for disposable a disposable food or drink item. The system 200 includes the steps of:
a. Drafting and editing a magazine, at step 202;
b. Printing multiple copies of the magazine for distribution to consumers, at step 204;
c. Manufacturing the labels for the bottles, at step 206;
d. Manufacturing the bottles, at step 208;
e. Manufacturing the caps for the bottles, at step 210; and
f. Manufacturing the cartons for packaging the bottles, at step 212.

The caps, cartons, bottles, magazines and labels are then shipped from the relevant manufactures to a bottler for assembly and packaging, at step 214. The magazines are coupled to the bottles by the bottler in accordance with any one of the above-described techniques. When this process has been completed, the cartons of bottled water are shipped to either the Grocery warehouse 216 or the route warehouse 218 where they are stored before being sent to supermarkets 220 and wholesalers 222.

The system 200 preferably includes that step of randomly allocating one of six different magazines to each bottle of water. In doing so, each carton of water bottles includes a mixture of associated magazines. Preferably the label laminate 172 is made of a clear material so that the covers of the magazines can be clearly read by consumers when the products are sitting in a refrigerator of a supermarket, for example.

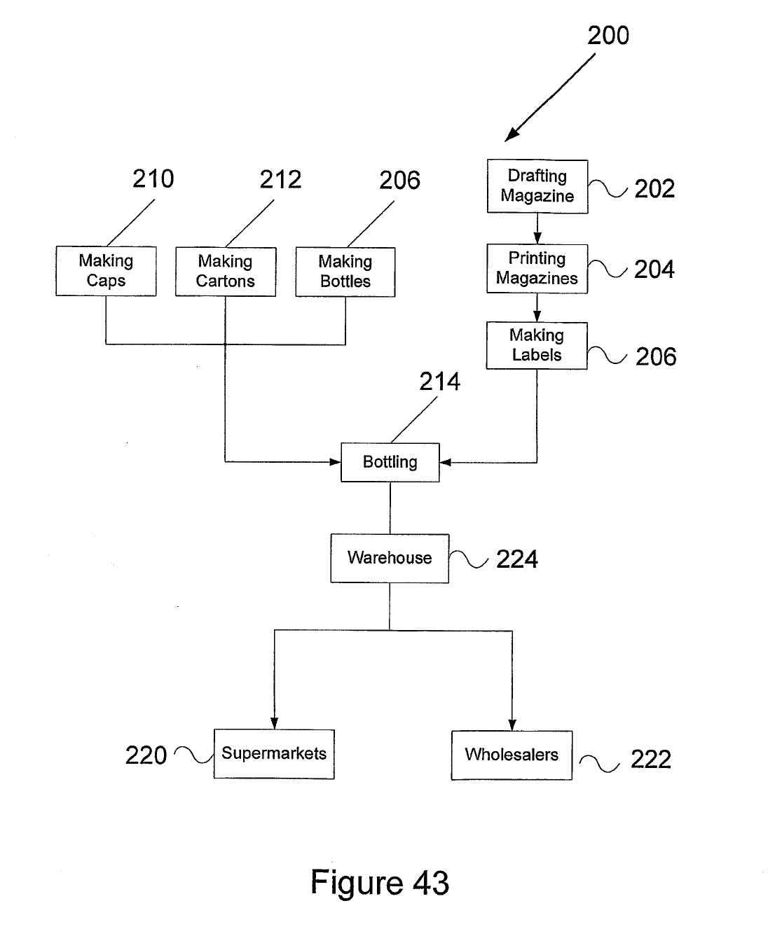

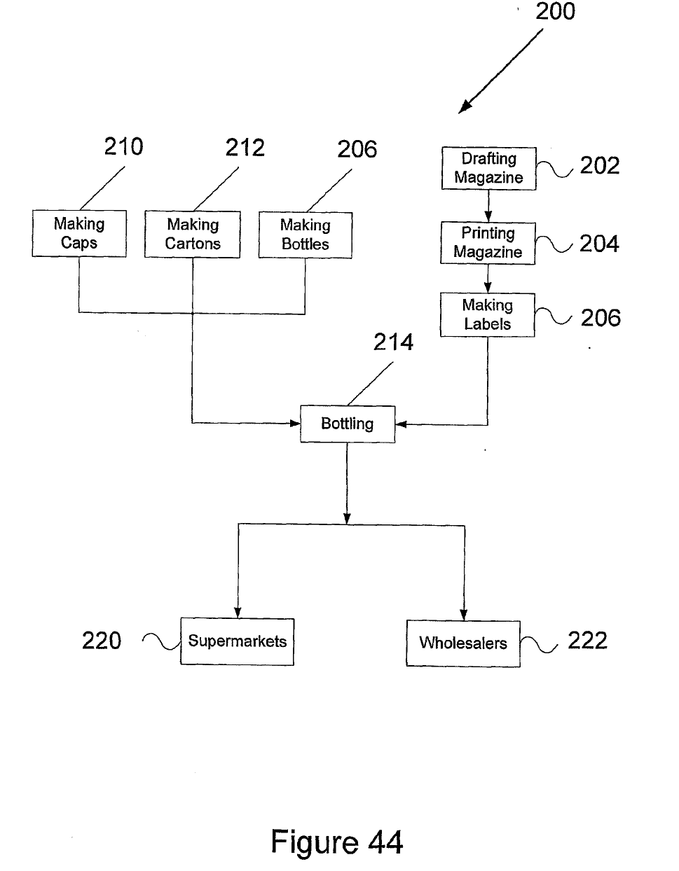

In the system 200 shown in FIG. 43, the Grocery Warehouse 216 and the Route Warehouse 218 are combined into the one Warehouse 224. The cartons of bottled water are stored at the Warehouse 224 before they are sent to supermarkets 220 and wholesalers 222. In the system shown in FIG. 44, the cartons of bottled water are sent straight to the supermarkets 220 and wholesalers 222 from the bottler.

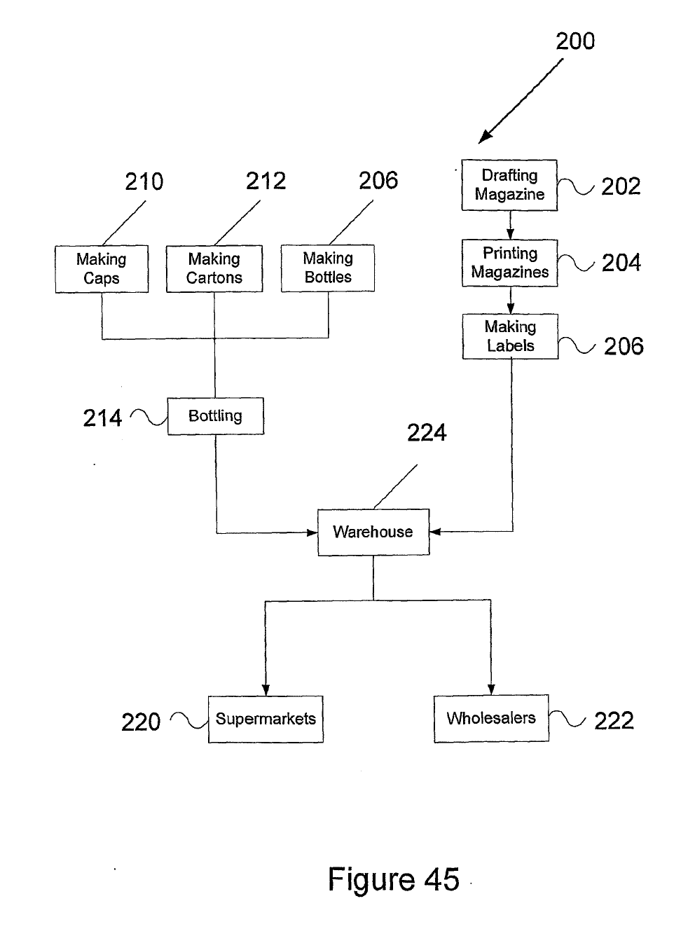

In the system 200 shown in FIG. 45, the caps, cartons, bottles are then shipped to a bottler for assembly, at step 214, and then, once assembled, they are sent to the warehouse 224. The magazines and labels are shipped to the warehouse 224 for coupling to the bottles. The magazines are coupled to the bottles in accordance with any one of the above-described techniques. When this process has been completed, the cartons of bottled water are shipped to supermarkets 220 and wholesalers 222.

While we have shown and described specific embodiments of the present invention, further modifications and improvements will occur to those skilled in the art. We desire it to be understood, therefore, that this invention is not limited to the particular forms shown and we intend in the append claims to cover all modifications that do not depart from the spirit and scope of this invention.

1-50. (canceled)

51. Packaging for a food or drink item, said packaging being adapted to secure said food or drink item therein, wherein a recessed section of an outer peripheral surface of the packaging is shaped to at least partially receive a booklet.

52. The packaging of claim 51, wherein the packaging is generally tubular.

53. The packaging of claim 51, further including the booklet coupled to the packaging.

54. The packaging of claim 53, wherein a front side of the booklet is generally parallel with the outer peripheral surface of the packaging when a back side of the booklet is seated in the recessed section.

55. The packaging of claim 51, wherein said recessed section is adapted to couple said booklet to the packaging.

56. The packaging of claim 55, wherein the recessed section is adapted to couple the booklet to the packaging by way of a fastener.

57. The packaging of claim 51, including a patch adapted to extend over said recessed section so as to couple the booklet to the packaging when the booklet is seated therein.

58. The packaging of claim 57, wherein the patch is secured to the outer peripheral surface of the packaging by a fastener.

59. The packaging of claim 57, wherein the patch is secondary packaging for the food or drink item.

60. The packaging of claim 51, wherein first and second opposed sides of the recessed section include corresponding lugs that extend over the recessed section towards their respective opposed sides, wherein the lugs are adapted to extend over the booklet when the booklet is seated in the recessed section to thereby couple the booklet to the packaging.

61. The packaging of claim 60, wherein the lugs extend substantially across the width of the first and second opposed sides of the recessed section.

62. The packaging of claim 52, wherein the tubular packaging is substantially triangular in cross-section and the recessed section extends around two sides of the triangular packaging.

63. The packaging of claim 62, wherein the recessed section of a first side of said two sides is adapted to at least partially receive a first part of the booklet, and the recessed section of a second side of said two sides is adapted to at least partially receive a second part of the booklet, such that a spine of the booklet bridges said two sides of the triangular packaging when the booklet is so arranged.

64. The packaging of claim 63, wherein the recessed section extends around a third side of the triangular packaging.

65. The packaging of claim 64, wherein the recessed section of said third side is adapted to at least partially receive a third part of the booklet, such that another spine of the booklet bridges said second side and said third side of the triangular packaging when the booklet is so arranged.

66. The packaging of claim 51, including means for coupling the booklet to the packaging.

67. The packaging of claim 66, wherein the means for coupling is secondary packaging for the food or drink item.

68. The packaging of claim 53, wherein the booklet is a magazine.

69. Packaging for a food or drink item, said packaging being adapted to secure said food or drink item therein, including a substantially tubular body and a hollow receptacle extending into said tubular body, the receptacle being adapted to receive, and seat therein, a booklet.

70. The packaging of claim 69, wherein the hollow receptacle is shaped to receive the booklet when the booklet is rolled up.

71. The packaging of claim 69, wherein the receptacle opens into a base section of the packaging and extends therefrom into said tubular body.

72. The packaging of claim 69, wherein an open end of the receptacle is coupled to a lid of the packaging and extends therefrom into said tubular body.

73. The packaging of claim 72, wherein the receptacle is adapted to be removed from the packaging when said lid is removed from the packaging.

74. The packaging of claim 69, further including a booklet coupled to the packaging.

75. The packaging of claim 74, wherein the booklet is a magazine.

76. Packaging for a food or drink item, said packaging being adapted to secure said food or drink item therein, wherein the packaging includes a booklet coupled thereto.

77. The packaging of claim 76, wherein the booklet is coupled to an outer peripheral surface of the packaging.

78. The packaging of claim 77, wherein the booklet is coupled to the outer peripheral surface of the packaging by secondary packing for the food or drink item.

79. The packaging of claim 78, wherein the secondary packaging is a label for said food or drink item.

80. The packaging of claim 77, wherein the booklet is coupled to the outer peripheral surface of the packaging by an envelope.

81. The packaging of claim 80, wherein the envelope includes a base cover coupled to the outer peripheral surface of the packaging and an outer cover coupled to the base cover so as to secure the booklet therebetween.

82. The packaging of claim 81, wherein the base cover includes first and second parts that are adapted to at least partially slide over one another when the envelope is wrapped around the outer peripheral surface of the packaging.

83. The packaging of claim 82, wherein the base cover and the outer cover are made of a material that is adapted to bind together as the envelope is wrapped around the outer peripheral surface of the packaging.

84. The packaging of claim 77, wherein the outer peripheral surface of the packaging is tubular.

85. The packaging of claim 76, wherein the packaging is bottle shaped and the booklet is coupled to the packaging by a bib that extends over a neck of the bottle and around a waist of the bottle.

86. The packaging of claim 76, wherein the packaging is bottle shaped and the booklet is coupled to the packaging by a hollow receptacle coupled over a neck of the bottle.

87. The packaging of claim 86, wherein the hollow receptacle is a cup.

88. The packaging of claim 76, wherein the booklet is a magazine.

89. A process for distributing booklets to retail stores, including the steps of:
(a) coupling said booklets to respective ones of the packaging for the food or drink item of claim 51; and
(b) distributing said respective ones of the packaging for the food or drink item, each having a booklet coupled thereto, to one or more of said retail stores.

90. The process of claim 89, wherein the booklets are magazines.

91. The process of claim 89, wherein the packaging is a bottle.

92. The process of claim 89, including the step of printing the booklet.

93. A system for distributing booklets to retail stores, including the steps of:
(a) coupling said booklets to respective ones of the packaging for the food or drink item of claim 69; and
(b) distributing said respective ones of the packaging for the food or drink item, each having a booklet coupled thereto, to one or more of said retail stores.

94. The system of claim 93, wherein the booklets are magazines.

95. The system of claim 93, wherein the packaging is a bottle.

96. The system of claim 93, including the step of printing the booklet.

97. Packaging for a disposable item, said packaging including a predetermined surface area bearing news and/or entertainment items.

98. The packaging of claim 97, wherein the news and/or entertainment items relate to a particular social demographic in a community.

99. The packaging of claim 97, wherein the disposable item is a consumable food or drink item.

100. A process for distributing news and/or entertainment items to the public, said process including the step of distributing the packaging of claim 97.
